(19) United States
(12) Patent Application Publication
(10) Pub. No.: US 2020/0062449 A1
(43) Pub. Date: Feb. 27, 2020

(54) TRANSPORT PALLET, TRANSPORT CONTAINER AND TRANSPORT VEHICLE WITH AT LEAST ONE OF SAME

(71) Applicants: Avdu Milan Marovac, Gummersbach (DE); Smigaj Azubischule GmbH, Gummersbach (DE)

(72) Inventors: Avdu Milan Marovac, Gummersbach (DE); Fritz Smigaj, Gummersbach (DE)

(21) Appl. No.: 16/546,782

(22) Filed: Aug. 21, 2019

Related U.S. Application Data
(60) Provisional application No. 62/720,243, filed on Aug. 21, 2018.

(51) Int. Cl. B65D 19/38; B65D 19/18; B65G 67/04

(52) U.S. Cl. CPC B65D 19/38; B65D 19/18; B65G 67/04; B65D 2519/0096; B65D 2519/00069; B65D 2519/00273; B65D 2519/00497; B65D 2519/00034

(57) ABSTRACT

In a transport pallet (1) having an upper side (10), a lower side (11), and at least four side parts (12, 13, 14, 15) or side surfaces arranged between and/or adjacent to the upper side (10) and the lower side (11), the transport pallet (1) can be provided or is provided with at least one rechargeable energy store (2), wherein the at least one rechargeable energy store (2) is configured for supplying energy to at least one electrical or electronic component (9) of a transport vehicle (8), wherein the transport pallet (1) has at least one energy transfer device (4) for transferring energy from the at least one rechargeable energy store (2) to the at least one electrical or electronic component (9) of the transport vehicle (8) and/or from at least one energy source (6, 7) to the rechargeable energy store (2).

### FIELD OF THE INVENTION

The invention relates to a transport pallet having an upper side, a lower side, and at least four side parts or side surfaces arranged between and/or adjacent to the upper side and the lower side, and to a transport vehicle having at least one electrical or electronic component, such as at least one electric drive, a transport container for transporting cargo, comprising a base and a number of wall parts, and having at least one transport surface for the arrangement of at least one transport pallet.

### BACKGROUND OF INVENTION

Transport pallets are known in the prior art in many different implementation variants. They are conventionally used for transporting cargo, which is arranged on the transport pallet and transported thereon. The known transport pallets are made of wood or plastics material. For transporting such transport pallets, it is known to use transport vehicles, such as trucks, which are provided with at least one transport surface on which the transport pallets are arranged. Such transport vehicles are nowadays known no longer with only conventional combustion engine drives but also with hybrid drives, for example with a combustion engine and an electric drive, and likewise with only an electric drive. However, specifically in the case of transport vehicles that are driven solely by an electric drive, there is a range problem, since the range of such a transport vehicle driven in particular solely by an electric drive is very limited depending on the topography of the landscape and on the cargo and accordingly the loads to be transported. According to DE 10 2011 056 921 A1, it is proposed to use a free space beneath a loading surface of a commercial vehicle trailer to arrange a power supply and/or storage device, which is connected to the towing vehicle in order to supply energy to the power train of the towing vehicle. However, such a configuration is very complex. Furthermore, it is necessary for a trailer to be carried along behind a towing vehicle of the transport vehicle, which in turn increases the weight and can accordingly lead to a range reduction owing to the greater load.

### SUMMARY OF THE INVENTION

Accordingly, the object underlying the present invention is to provide a transport pallet having an upper side, a lower side, and at least four side parts or side surfaces arranged between and/or adjacent to the upper side and lower side, and a transport vehicle having at least one electric drive and at least one transport surface for attachment of at least one such transport pallet, by means of which the above problems can be overcome and, optionally, even greater loads can be transported without problems.

The object is achieved for a transport pallet having an upper side, a lower side, and at least four side parts or side surfaces arranged between and/or adjacent to the upper side and the lower side, wherein the transport pallet can be provided or is provided with at least one rechargeable energy store, wherein the at least one rechargeable energy store is configured to supply energy to at least one electrical or electronic component of a transport vehicle, wherein the transport pallet has at least one energy transfer device for transferring energy from the at least one rechargeable energy store to the at least one electrical or electronic component of the transport vehicle and/or from at least one energy source to the rechargeable energy store. For a transport container for transporting cargo, comprising a base and a number of wall parts, the object is achieved in that at least one such transport pallet is provided as the base and can be connected or is connected to the number of wall parts and/or door-like elements. For a transport vehicle having at least one electrical or electronic component, such as at least one electric drive, ad having at least one transport surface for arrangement of at least one transport pallet, the object is achieved in that the transport vehicle can be provided or is provided with at least one terminal device or connecting device for transferring energy from the at least one rechargeable energy store of the transport pallet to at least one electrical or electronic component of the transport vehicle. Further developments of the invention are defined in the dependent claims.

There is thus provided a transport pallet by means of which it is possible to significantly increase the range of the transport vehicle, which comprises at least one electric drive, since the rechargeable energy store of the transport pallet is able to supply the electric drive of the transport vehicle with energy. The transport pallet is for this purpose arranged on the transport surface of the transport vehicle, and the at least one rechargeable energy store of the transport pallet is connected to the electric drive of the transport vehicle via the at least one energy transfer device for energy transfer. However, the at least one rechargeable energy store of the transport pallet can not only be used for supplying energy to the at least one electric drive of the transport vehicle and thus for increasing the range of the transport vehicle, but the energy provided by the at least one rechargeable energy store of the transport pallet can also be used to supply energy to other electrical or electronic components of the transport vehicle, such as, for example, for operating an air conditioning or cooling unit of the transport vehicle which serves, for example, to air-condition the interior of the transport vehicle. By suitably choosing the number of transport pallets each having at least one rechargeable energy store that are also carried, a desired amount of energy can be provided for the electrical or electronic components, in particular at least one electric drive, of the transport vehicle. The transport pallets loaded with the cargo to be transported can be arranged on the at least one transport surface of the transport vehicle and thus fulfill their actual purpose. For example, transport pallets which are empty after being unloaded can be carried on the transport surface of the transport vehicle in stacked form, for example, and thus likewise serve to supply energy to the transport vehicle. After the transport pallets have been unloaded from the transport vehicle, the transport pallets in the loaded and also in the unloaded state can be connected to an energy source in order to recharge the at least one rechargeable energy store of the transport pallet again. Optionally, the at least one energy store can first be discharged and subsequently charged. Accordingly, the transport vehicle can always be loaded with transport pallets having charged rechargeable energy stores, so that the energy stores are always available for supplying energy to the at least one electric drive of the transport vehicle or to further electrical or electronic components of the transport vehicle.

Specifically in the case of small transport vehicles having only a small transport surface, on which there is space, for example, for only one transport pallet or a stack of stacked transport pallets, the range can be increased enormously when the transport pallets provided with the at least one rechargeable energy store are used, since the weight of the transport vehicle is comparatively small. Such small transport vehicles can accordingly advantageously be used for delivering goods, or cargo, which are transported on the transport pallets in a limited radius, in particular also in rural areas, in which provision with electric vehicle charging stations is low, without the risk of a breakdown.

The at least one rechargeable energy store can further advantageously be integrated into the transport pallet, in particular received in the inside of the transport pallet between its upper side, lower side and at least four side parts or side surfaces. For this purpose, the transport pallet can have at least one receiver in which the at least one rechargeable energy store can be received or is received. For example, the transport pallet is of modular construction with at least two parts and comprises at least one lower part and at least one upper part, wherein the at least one rechargeable energy store is arranged in the inside of the upper part and/or lower part. The upper part and/or the lower part can accordingly be at least in part in the form of hollow bodies.

Further components can advantageously also be arranged in the inside of the at least one upper part and/or lower part. In particular, at least one electronic charging unit for the at least one rechargeable energy store can be arranged in or on or in the inside of the transport pallet. The electronic charging unit serves to permit or to control or regulate the charging and discharging of the at least one rechargeable energy store of the transport pallet. In order to avoid long cable runs, the electronic charging unit is advantageously arranged adjacent to the at least one rechargeable energy store.

Further advantageously, the transport pallet can be made of at least one plastics material. For example, the transport pallet can be made of at least one at least partially reinforced plastics material. Especially the regions of the transport pallet that are subjected to particularly high static and/or dynamic loads can be formed of at least one reinforced plastics material, such as, for example, a fiber-reinforced plastics material, while the remaining regions of the transport pallet can optionally also be formed of at least one unreinforced plastics material. In principle, it is of course likewise possible to produce the transport pallet at least in part from at least one material other than a plastics material. If the transport pallet is produced from at least one plastics material, it can advantageously be produced by an injection molding process.

The at least one energy transfer device for transferring energy from and to the at least one rechargeable energy store can be configured, for example, to be suitable for cabled energy transfer, in particular in the form of a socket for energy transfer via at least one cable which can be plugged or is plugged into the socket. It is likewise possible to configure the at least one energy transfer device for cable-free energy transfer, for example for inductive energy transfer. By configuring for cable-free energy transfer, there is no risk, specifically on the outside of a transport pallet, that components of the energy transfer device could be contaminated or even damaged while the transport pallet is being used for transporting cargo, for example by a fork lift truck. Specifically, when configuring for cabled energy transfer via the at least one energy transfer device, the energy transfer device can particularly advantageously be in the form of at least one socket which can be arranged in particular on one of the side parts or side surfaces of the transport pallet. Undesirable damage to the energy transfer device can thereby likewise be avoided, since such a socket can be configured to project into the inside of the transport pallet, and the socket thus does not protrude, or at least substantially does not protrude, on the outside of the transport pallet, so that damage thereto can at least largely be avoided. Via at least one cable, the energy transfer device of the transport pallet can be connected either to a correspondingly configured terminal device on the transport vehicle, into which a cable can thus be plugged, or to an energy transfer device of an adjacent transport pallet or, for charging the at least one rechargeable energy transfer device, to an energy source or charging station. Also in the case of cable-free energy transfer, a connection can be made on the one hand with a corresponding terminal device on the transport vehicle or with a corresponding cable-free energy transfer device of an adjacent transport pallet or with an energy source or charging station for charging the rechargeable energy store. The combination of cabled and cable-free energy transfer devices is also possible in particular on a transport pallet. Even more universal use of the transport pallet is thereby possible, since connection is possible both to cabled and cable-free terminal devices on the transport vehicle or to an energy source for charging the at least one rechargeable energy store of the at least one transport pallet.

It is found to be further advantageous to arrange at least one readable data carrier in and/or on the transport pallet, for example at least one RFID transponder, at least one SIM card, which can also be a permanently installed or installable data card suitable for machine-to-machine communication (M2M), which permits problem-free and clear communication even of larger amounts of data, or at least one other data carrier, for storing data of the at least one rechargeable energy store of the transport pallet and/or data permitting the tracking and identification of the at least one rechargeable energy store and/or of the transport pallet. By means of such a readable data carrier it is possible to store all data, in particular current data, of the at least one rechargeable energy store of the transport pallet on the transport pallet securely and in such a manner that it can be read at any time. In particular, the age of the rechargeable energy store, its charging cycles, etc. can be stored on the readable data carrier and read therefrom in particular contactlessly at any time. Such a readout can take place, for example, via the on-board system of the transport vehicle, but also during recharging of the rechargeable energy store(s) in the region of an energy source or charging station therefor. Furthermore, display devices for displaying the state of the rechargeable energy stores can be provided either in the region of the transport pallet or readable therefrom or remote from the transport pallet, for example in the transport vehicle. Tracking of the respective transport pallet can also take place, for example via GPS or another tracking system, if the respective coordinates are likewise stored, or constantly acquired and stored, in the readable data carrier of the transport pallet. Tracking and identification not only of the cargo transported on the transport pallet but also of the transport pallet itself, and optionally also of the transport vehicle transporting it, can thereby be carried out for logistics purposes. Furthermore, the particular cargoes transported on the transport pallets, as well as further data, such as temperature profiles during their transport and storage, etc., can likewise be stored in the data carrier, if it is desired, for example, for documentation purposes, etc.

Since the transport pallet, or the at least one rechargeable energy store arranged therein, can be discharged and charged again whenever the respective transport pallet is not being transported on a transport vehicle, the charging time, or discharging time, that is required in each case is in principle unimportant, since a sufficient number of transport pallets with charged rechargeable energy stores can always be kept ready for loading with cargo. Accordingly, it is not absolutely essential to use rapidly chargeable rechargeable energy stores in the at least one transport pallet. Accordingly, less expensive rechargeable energy stores can also be used in the transport pallets.

In order to able to transport different cargo on the transport pallet, the transport pallet can be used not only as a pallet but together with wall parts or door-like elements, and boxes or containers can thereby be formed. Accordingly, the transport pallet advantageously has at least one device for connection to one or more wall parts and/or door-like elements. In particular, wall parts and/or door-like elements which are closed and/or provided with openings and/or lattice-like can be connected via the at least one device for connection to the transport pallet. For example, such a device for connection can be a groove and/or a shoulder in or on the transport pallet, in particular the upper side thereof, with which a corresponding shaping of complementary form on the wall parts or door-like elements can engage and be held securely. The individual wall parts or door-like elements can also be connected to one another and/or to the transport pallet via corresponding connecting devices, in particular also in an articulated or folding manner. Accordingly, lattice-box-like superstructures can be formed, as can closed containers with or without doors, which can be constructed by the door-like elements in conjunction with the wall parts. The transport container can be in the form of a container, closed on all sides, having the at least one transport pallet as the base, side wall parts, such as, for example, four wall parts, and/or door-like elements, and at least one lid part, or in the form of a box, in which case no lid part is provided.

For example, the transport container can be in the form of a refrigerated container. As a result of the arrangement of the at least one rechargeable energy store in the transport pallet, a refrigerating unit can thereby be fed with electrical energy, so that the refrigerated container is able to refrigerate the cargo without problems during transport. Accordingly, such a refrigerated container can be transported on the transport vehicle in particular as an independent system which does not put a strain on the battery or power supply of the transport vehicle. In order to ensure an adequate energy supply for the refrigerated container, it is possible, for example, also to carry an additional transport pallet for support, in order to provide additional energy by means of its at least one rechargeable energy store. Furthermore, energy for the electric drive of the transport vehicle can also be provided thereby.

The transport pallets can be formed with different dimensions. Adaptation to cargoes of different sizes is thus possible. Furthermore, the transport pallets are advantageously in stackable form, in particular independently of their dimensions, which may be different. In order to prevent the stacked transport pallets from moving relative to one another, projections, recesses and/or snap-in devices can be provided in particular on the upper and/or lower side of a respective transport pallet in order to lock stacked transport pallets in place. It is likewise possible to stack transport pallets which have been reconfigured or supplemented to form transport containers and/or boxes. Here too, a relative movement of the stacked transport containers, transport boxes, transport pallets can be prevented by such devices which prevent such a movement, such as projections, recesses, snap-in devices in particular on the upper and/or lower side of a transport pallet and/or the wall parts and/or door-like elements and/or lid parts. It is possible in particular to provide projecting devices which prevent a relative movement of stacked transport pallets or transport containers or boxes. Interengaging surfaces on transport pallets, wall parts, lid parts can also be provided for preventing transport pallets and/or transport containers and/or transport boxes from moving relative to one another.

By forming the at least one transport pallet of at least one plastics material, the at least one rechargeable energy store arranged therein can be protected externally against weathering influences. By providing seals between in particular at least an upper part and at least a lower part of the transport pallet, the inside of the transport pallet can be sealed against the penetration of moisture.

In addition to the arrangement of the at least one rechargeable energy store in at least one receiver in the transport pallet, such a rechargeable energy store can also be integrated directly into the transport pallet during injection molding thereof, provided that the thermal and mechanical stresses that occur thereby do not result in damage to the rechargeable energy store. However, in order to permit subsequent simple replacement of a rechargeable energy store which may have aged and no longer be operating optimally or no longer be charging optimally, it is preferred not to mold it into the material in the transport pallet but in particular to arrange it in a receiver provided therein, as is also the case for the at least one electronic charging unit of the at least one rechargeable energy store.

### BRIEF DESCRIPTION OF THE DRAWINGS

In order to explain the invention in greater detail, exemplary embodiments thereof will be described hereinbelow with reference to the drawings, in which:

FIG. 1 is a perspective top view of a first embodiment of a transport pallet according to the invention;

FIG. 2 is an exploded perspective view of the transport pallet according to FIG. 1;

FIG. 3 is a longitudinal sectional view through the transport pallet according to FIG. 1;

FIG. 4 is a bottom view of the transport pallet according to FIG. 1;

FIG. 5 is a perspective view of a stack of pallets containing four transport pallets according to FIG. 1;

FIG. 6 is a perspective view of a stack of pallets containing three stacked transport pallets according to the invention of different dimensions;

FIG. 7 is a perspective view of a lattice box according to the invention having four lattice-like wall parts and a transport pallet according to FIG. 1 as the base;

FIG. 7a is an exploded view of the lattice box according to FIG. 7;

FIG. 8 is a perspective view of a transport box according to the invention having four wall parts provided with slot-like openings and a transport pallet according to FIG. 1 as the base;

FIG. 8a is an exploded perspective view of the transport box according to FIG. 8;

FIG. 9 is a perspective view of a transport container according to the invention having four wall parts, a lid part and a transport pallet according to FIG. 1 as the base;

FIG. 9a is an exploded perspective view of the transport container according to FIG. 9;

FIG. 10 is a perspective view of a transport container according to the invention having three wall parts, two door-like elements, a lid part and a transport pallet according to FIG. 1 as the base;

FIG. 10a is a perspective view of the transport container according to FIG. 10 with the door-like elements open;

FIG. 11 is a side view in the form of a schematic diagram of a first embodiment of a transport vehicle according to the invention with a transport container according to the invention having a transport pallet according to the invention received thereon;

FIG. 12 is a side view in the form of a schematic diagram of the transport vehicle according to FIG. 11 with a stack of nine stacked transport pallets according to the invention;

FIG. 13 is a side view in the form of a schematic diagram of a further embodiment of a transport vehicle with a stack of transport pallets according to the invention mounted on its transport surface;

FIG. 14 is a side view in the form of a schematic diagram of the transport vehicle according to FIG. 13 with further transport containers according to the invention positioned on its transport surface in addition to the stack of transport pallets;

FIG. 15 is a side view in the form of a schematic diagram of the transport vehicle according to FIG. 13 with transport containers according to the invention positioned in two layers on its transport surface;

FIG. 16 is a side view in the form of a schematic diagram of a further embodiment of a transport vehicle with a towing vehicle and a trailer, wherein, in addition to a stack of transport pallets according to the invention, further transport containers are arranged on its transport surface;

FIG. 17 is a perspective view of a stack of pallets containing stacked transport pallets according to the invention, each of which has at least one cable-free energy transfer device, positioned at a charging station for the cable-free charging of energy stores of the transport pallets;

FIG. 18 is an exploded perspective view of a transport pallet according to the invention having an energy transfer device in the form of two sockets, one of which is connected via a cable to a charging station;

FIG. 18a is a perspective side view of the arrangement according to FIG. 18;

FIG. 18b is a further perspective view of the arrangement according to FIG. 18;

FIG. 19 is a perspective view of a stack of pallets containing four stacked transport pallets according to FIG. 18, wherein the stacked transport pallets are connected together in the region of the sockets via cables; and

FIG. 19a is a detail of the uppermost transport pallet of the stack according to FIG. 19 and of the transport pallet arranged beneath it, in the region of the sockets and the cables plugged into the sockets.

### DETAILED DESCRIPTION OF THE INVENTION

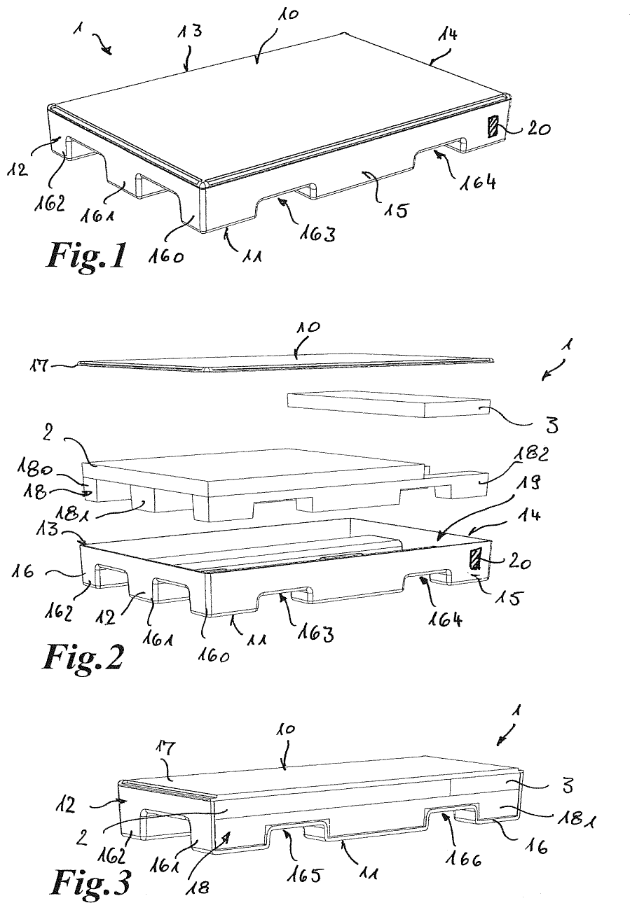

FIGS. 1 to 4 show a first embodiment of a transport pallet 1, comprising an upper side 10, a lower side 11, and four side parts 12, 13, 14, 15 arranged between or adjacent thereto. As is apparent in particular from the exploded view in FIG. 2, the transport pallet 1 is of multi-part or modular construction and has a housing lower part 16 provided with cavities, a lid part 17, which is attached thereto and closes it to the outside, and a carrier part 18 which can be inserted into the housing lower part 16 and carries a rechargeable energy store 2 and an electronic charging unit 3. The housing lower part 16 comprises the lower side 11 of the transport pallet 1 and its four side parts or surfaces 12, 13, 14, 15. The lid part 17 has the upper side 10 of the transport pallet 1, when it is attached to the housing lower part 16 or is connected thereto.

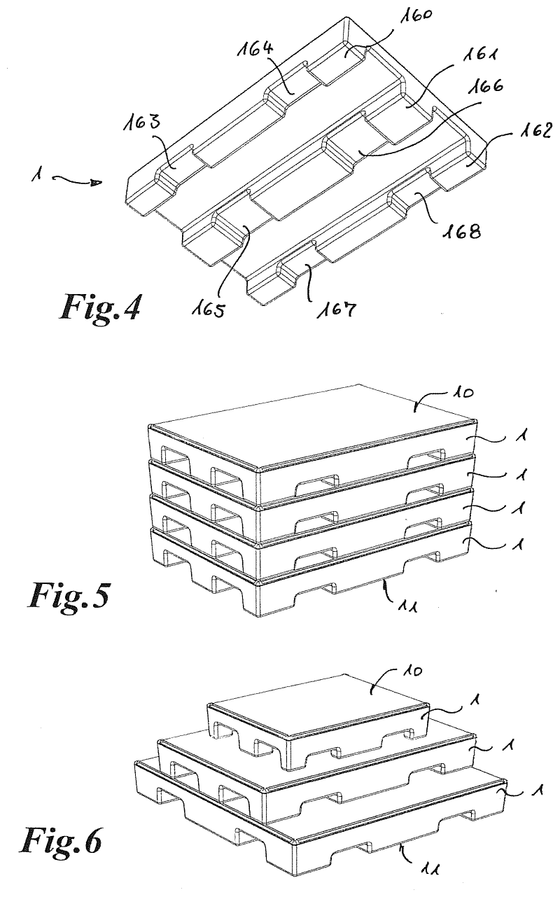

The electronic charging unit 3 is connected to the rechargeable energy store 2, this not being shown in detail in the embodiment variant of the transport pallet 1 shown in FIGS. 1 to 4. As is apparent from FIGS. 2 and 3, the electronic charging unit 3 is arranged on the carrier part 18 directly adjacent to the rechargeable energy store 2, and the carrier part 18, together with the rechargeable energy store 2 arranged thereon and the electronic charging unit 3, is received in the inner cavity 19 of the housing lower part 16, and the transport pallet 1 is closed to the outside by fitting the lid part 17 to the housing lower part 16. The components of the energy store 2 and of the electronic charging unit 3 that are arranged in the inside of the transport pallet 1 can thereby be sealed to the outside and encapsulated. In particular, the housing lower part 16, the lid part 17 and optionally the carrier part 18 in the inside of the transport pallet 1 are made of at least one plastics material. At least the regions of the transport pallet that are subjected to static and/or dynamic loads can be made from a reinforced plastics material, for example fiber-reinforced plastics material. The shaping of the housing lower part 16 of the transport pallet 1 is suitably shaped for the engagement of forks of a fork lift truck. It has longitudinal ribs 160, 161, 162 which have transverse grooves 163, 164, 165, 166, 167, 168 arranged in the transverse direction of the transport pallet, that is to say approximately 90° to the longitudinal extent of the longitudinal ribs 160, 161, 162. The longitudinal ribs 160, 161, 162 can be seen particularly clearly in the bottom view of the transport pallet in FIG. 4. In the embodiment shown in FIG. 2, the carrier part 18 comprises three carrier rails 180, 181, 182 on which the rechargeable energy store 2 and the electronic charging unit 3 are arranged and which are introduced into the inner cavities of the longitudinal ribs 160, 161, 162 of the housing lower part 16 and thus reinforce them.

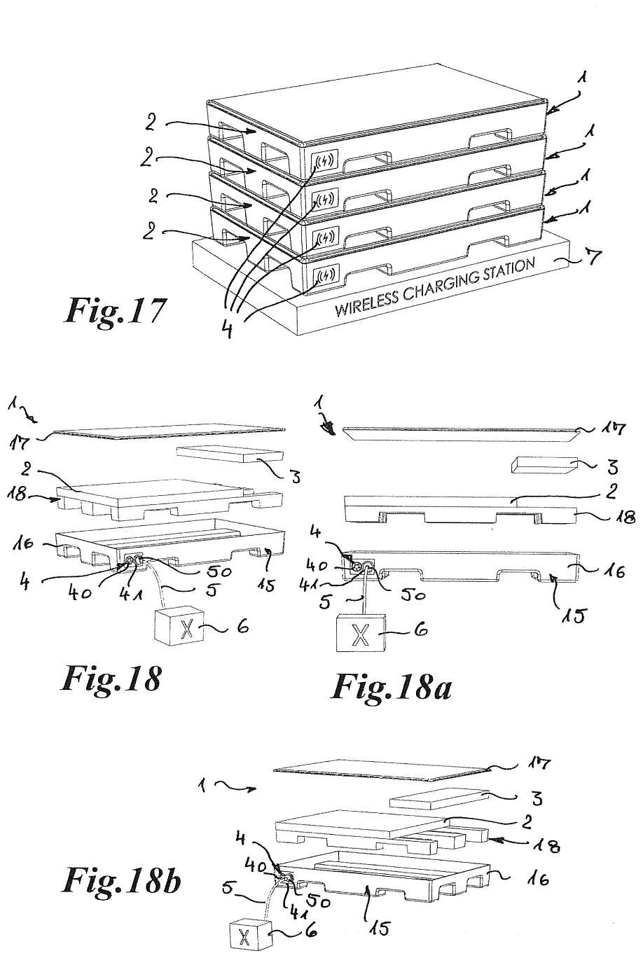

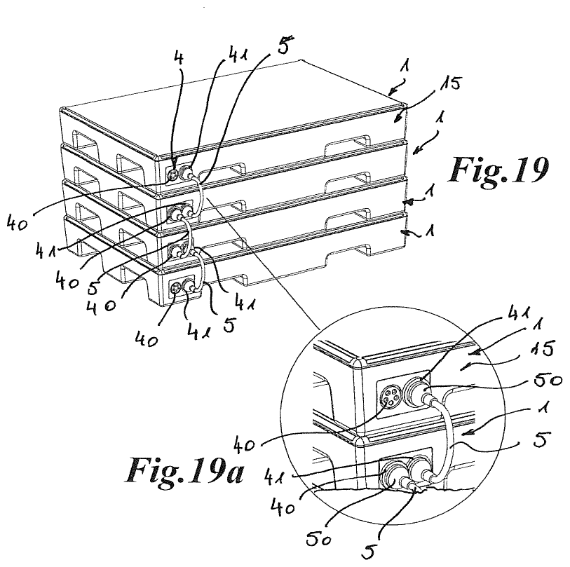

As can be seen in particular in FIGS. 17 to 19a, the transport pallet 1 has at least one energy transfer device 4 for charging and for energy transfer in respect of the energy store 2. In the embodiment according to FIG. 17, the energy transfer device is of cable-free, for example inductive, form, while in the embodiments according to FIGS. 18, 18a and 18b and 19, 19a they are arranged in cabled form by the provision of a respective socket 40, 41 on the respective outer side of the side part 15 of the transport pallet 1. Of course, sockets 40, 41 can also or additionally be arranged on one of the other side parts of the transport pallet 1. Cables 5 with plugs 50, which permit connection, for example, to an energy source or charging station 6, can be plugged into the sockets 40, 41 of the energy transfer device 4. Likewise, a plurality of transport pallets 1 can be connected together via such cables 5, which are plugged into the respective sockets 40, 41 of the transport pallets arranged one above the other. This is shown by way of example in FIG. 19, 19a. A cable-free, or inductive, connection to a charging station 7 is shown by way of example in FIG. 17. The stacked transport pallets 1 can thereby be connected to one another and to the cable-free charging station 7 in a cable-free manner, for example inductively, in order to charge, or first discharge and then charge again, the respective rechargeable energy store 2 in the respective transport pallet 1.

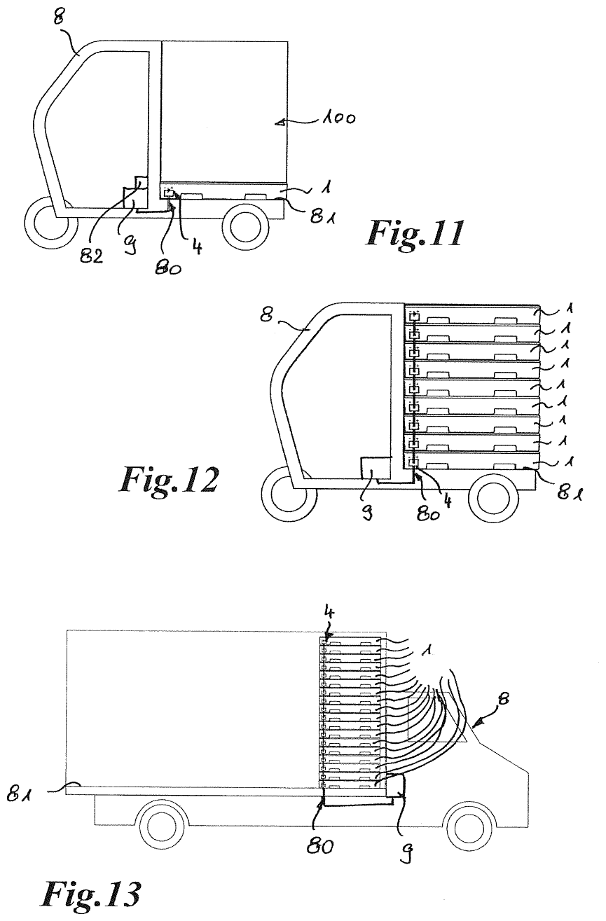

Via the respective energy transfer devices 4 of the transport pallets 1 it is possible not only to charge the rechargeable energy stores 2 arranged inside the transport pallets but also to transfer their energy, for example, to an electric drive 9 of a transport vehicle 8 or other electrical or electronic components thereof, as is shown by way of example in FIGS. 11 to 16. As can be seen in particular in FIG. 11, the transport pallet 1, or the at least one rechargeable energy store 2 located therein, is electrically connected via the energy transfer device 4 of the transport pallet to the transport vehicle 8 via a terminal device 80 of the transport vehicle. In particular, a mechanical connection is also provided in this region, in order to avoid unintentional slipping of the transport pallet 1 on a transport surface 81 of the transport vehicle 8, on which the transport pallet 1 is positioned, in particular in the region of the terminal device 80. The terminal device 80 on the transport vehicle 8 is connected, for example, to the electric drive 9 of the transport vehicle 8, in order to supply the electric drive with energy via the rechargeable energy store 2. In the case of a stack of stacked transport pallets 1, as indicated in FIGS. 12, 13, 14, 16, a large amount of energy can be provided for the transport vehicle or the electric drive thereof. The range of the vehicle can thus be increased significantly. On the other hand, further devices of the transport vehicle that are to be supplied with energy can also be fed, such as, for example, an air conditioning device 82 for cooling the interior of the transport vehicle.

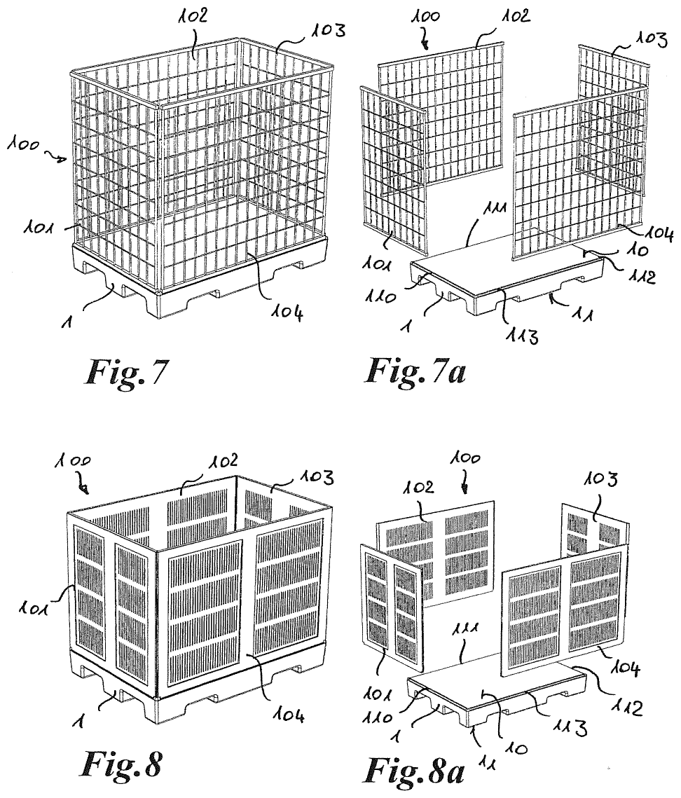

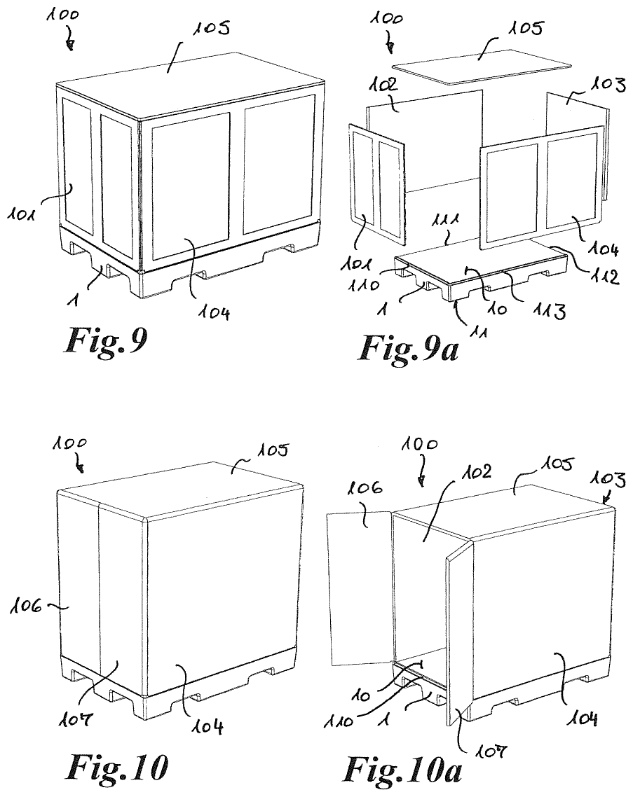

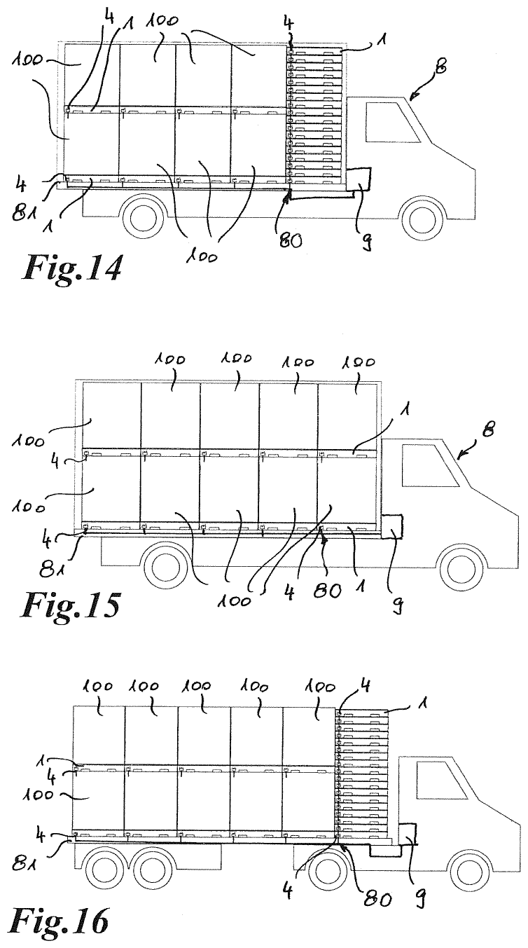

In addition to the stacking of the transport pallets 1, transport containers 100 which comprise the transport pallets 1 as bases can also be stacked, as is likewise apparent from FIGS. 14 to 16. The energy transfer devices 4 of the respective transport pallets 1 can be connected together via integrated lines, separate cables or also in a cable-free manner through the transport containers 100, or their lid parts 105, wall parts 101, 102, 103, 104 and/or door-like elements 106. In the transport vehicle according to FIG. 11, only one such transport container 100 is positioned on the transport surface 81 thereof. Such a transport container 100 can be formed by attaching wall parts 101, 102, 103, 104 and optionally at least one lid part 105 to the transport pallet forming the base of the transport container 100, as is shown by way of example in FIGS. 7 to 10a, The wall parts 101, 102, 103, 104 may thereby be in lattice form, in order to form lattice-box-like transport boxes as shown in FIGS. 7 and 7a, or may comprise wall parts 101, 102, 103, 104 provided with slot-like openings, as shown in FIGS. 8, 8a, or may have closed wall parts 101, 102, 103, 104 as can be seen in FIGS. 9, 9a. The lid part 105 is there attached to the upper side of the wall parts in order to close the transport container 100 at the top. In the embodiment variant of the transport container shown in FIGS. 10, 10a, two door-like elements 106, 107 are provided in place of one wall part, in order to allow the transport container 100 to be opened and closed. The wall parts 101, 102, 103, 104 or door-like elements 106, 107 can be positioned in grooves 110, 111, 112, 113 on the upper side 10 of the transport pallet 1 and fixed, for example locked or fixedly clamped, therein.

A transport container 100 provided in particular with door-like elements 106, 107 can in particular also be in the form of a refrigerated container for receiving refrigerated goods, which can be transported in the refrigerated state therein. The electrical energy required to operate a refrigerating unit can be provided by the at least one rechargeable energy store 2 of the transport pallet 1, so that the refrigerated container is not only independent of the power supply of the transport vehicle 8 but can continue to be supplied with power by the rechargeable energy store of the transport pallet 1 of the transport container 100 in the form of the refrigerated container even when it is being intermediately stored.

The transport pallets 1 can be stacked without difficulty, this being equally possible in the case of transport pallets 1 of the same dimensions and in the case of transport pallets 1 of different dimensions, as is apparent from FIGS. 5 and 6. In order to prevent the stacked transport pallets 1 from slipping, projections, recesses or other devices that prevent slipping, for example also surface roughness, optionally provided on only part of the surface, can be provided in particular on the upper side 10, but also on the lower side 11 of the transport pallets 1.

As is further apparent from FIG. 1, the transport pallet 1 is provided with a readable data carrier, here in the form of an RFID transponder 20, for storing the data of the rechargeable energy store 2, such as age, charging cycles, etc. The RFID transponder 20 can be read in a cable-free manner, so that the state of the rechargeable energy store 2 can be checked at any time and the rechargeable energy store can be replaced in good time with a new one if this appears necessary. The readable data carrier or RFID transponder 20 can be arranged in the inside of the transport pallet 1, integrated into the material thereof, or also arranged on the outside of the transport pallet 1. Instead of an RFID transponder, another type of readable data carrier can also be used, such as, for example, a mobile or permanently installed or installable SIM card, whereby the latter can in particular be suitable for machine-to-machine communication and in particular permits the transfer or exchange of even large amounts of data.

It is accordingly possible to provide any desired combinations of transport pallets 1 and transport containers 100 produced on the basis thereof. The amount of energy provided for the transport vehicle 8 can be determined by the number of rechargeable energy stores in the respective transport pallets 1 and thus also by the transport pallets 1, or transport containers 100 formed therefrom, that are also carried.

In addition to the embodiment variants of transport pallets, transport containers and transport vehicles described hereinabove and in the figures, it is possible also to form many further embodiment variants therewith, including any desired combinations of the above-mentioned features, wherein in each case at least one rechargeable energy store is arranged in or on the transport pallet, which energy store is configured or serves to supply energy to at least one electric drive or an electrical or electronic component of the transport vehicle and wherein the transport pallet is provided with at least one energy transfer device for transferring energy from the at least one rechargeable energy store to the electric drive or the at least one electrical or electronic component of the transport vehicle.

### LIST OF REFERENCE NUMERALS

1 Transport pallet
2 Rechargeable energy store
3 Electronic charging unit
4 Energy transfer device
5 Cable
6 Energy source/charging station
7 Cable-free charging station
8 Transport vehicle
9 Electric drive
10 Upper side
11 Lower side
12 Side part/side surface
13 Side part/side surface
14 Side part/side surface
15 Side part/side surface
16 Housing lower part
17 Lid part
18 Carrier part
19 Inner cavity of 16
20 RFID transponder/readable data carrier
40 Socket
41 Socket
50 Plug
80 Terminal device
81 Transport surface
82 Air conditioning device
100 Transport container
101 Wall part
102 Wall part
103 Wall part
104 Wall part
105 Lid part
106 Door-like element
107 Door-like element
110 Groove
111 Groove
112 Groove
113 Groove
160 Longitudinal rib
161 Longitudinal rib
162 Longitudinal rib
163 Transverse groove
164 Transverse groove
165 Transverse groove
166 Transverse groove
167 Transverse groove
168 Transverse groove
180 Carrier rail
181 Carrier rail
182 Carrier rail

What is claimed is:

1. A transport pallet comprising:
an upper side, a lower side, and at least four side parts or side surfaces arranged between and/or adjacent to the upper side and the lower side,
wherein the transport pallet can be provided or is provided with at least one rechargeable energy store,
wherein the at least one rechargeable energy store is configured to supply energy to at least one electrical or electronic component of a transport vehicle,
wherein the transport pallet has at least one energy transfer device for transferring energy from the at least one rechargeable energy store to the at least one electrical or electronic component of the transport vehicle and/or from at least one energy source to the rechargeable energy store.

2. The transport pallet as claimed in claim 1, wherein the at least one energy transfer device is configured for cabled energy transfer, in particular comprises at least one socket for energy transfer via a cable which can be plugged into the socket.

3. The transport pallet as claimed in claim 1, wherein the at least one energy transfer device is configured for cable-free energy transfer, in particular for inductive energy transfer.

4. The transport pallet as claimed in claim 1, wherein at least one electronic charging unit is arranged in or in the inside of the transport pallet.

5. The transport pallet as claimed in claim 1, wherein the transport pallet has at least one receiver in which the at least one rechargeable energy store is received or can be received, in particular at least one inner cavity.

6. The transport pallet as claimed in claim 1, wherein the transport pallet is made of at least one plastics material, in particular at least one at least partially reinforced plastics material.

7. The transport pallet as claimed in claim 1, wherein at least one readable data carrier can be arranged or is arranged in and/or on the transport pallet, in particular at least one RFID transponder, for storing data of the at least one rechargeable energy store and/or data permitting the tracking and identification of the at least one rechargeable energy store and/or of the transport pallet.

8. The transport pallet as claimed in claim 1, wherein the transport pallet has at least one device for connecting the transport pallet to one or more wall parts and/or door-like elements, in particular wall parts and/or door-like elements which are closed and/or provided with openings and/or lattice-like.

9. The transport pallet as claimed in claim 8, wherein at least four wall parts and/or door-like elements are connected to the transport pallet to form a box or a transport container, in particular a refrigerated container.

10. A transport container for transporting cargo, comprising:
a base and a number of wall parts, wherein
at least one transport pallet as claimed in claim 1 is provided as the base and can be connected or is connected to the number of wall parts and/or door-like elements.

11. The transport container as claimed in claim 10, wherein
the transport container is in the form of a container, closed on all sides, having the at least one transport pallet as the base, side wall parts and/or door-like elements, and at least one lid part, in particular in the form of a refrigerated container.

12. A transport vehicle, comprising:
at least one electrical or electronic component, such as at least one electric drive, and having at least one transport surface for the arrangement of at least one transport pallet as claimed in claim 1, wherein the transport vehicle can be provided or is provided with at least one terminal device or connecting device for transferring energy from the at least one rechargeable energy store of the transport pallet to at least one electrical or electronic component of the transport vehicle.

13. The transport vehicle as claimed in claim 12, wherein the transport pallet is in the form of a box or transport container, in particular a refrigerated container.

14. The transport vehicle as claimed in claim 13, wherein the at least one rechargeable energy store of the transport pallet is provided for supplying energy for a cooling device for cooling the interior of the transport vehicle or an air conditioning device of the transport vehicle.

15. The transport pallet as claimed in claim 2, wherein the at least one energy transfer device is configured for cable-free energy transfer, in particular for inductive energy transfer, and wherein at least one electronic charging unit is arranged in or in the inside of the transport pallet.

16. The transport pallet as claimed in claim 15, wherein the transport pallet has at least one receiver in which the at least one rechargeable energy store is received or can be received, in particular at least one inner cavity, and wherein the transport pallet is made of at least one plastics material, in particular at least one at least partially reinforced plastics material.

17. The transport pallet as claim in claim 16, wherein at least one readable data carrier can be arranged or is arranged in and/or on the transport pallet, in particular at least one RFID transponder, for storing data of the at least one rechargeable energy store and/or data permitting the tracking and identification of the at least one rechargeable energy store and/or of the transport pallet, wherein the transport pallet has at least one device for connecting the transport pallet to one or more wall parts and/or door-like elements, in particular wall parts and/or door-like elements which are closed and/or provided with openings and/or lattice-like, and wherein at least four wall parts and/or door-like elements are connected to the transport pallet to form a box or a transport container, in particular a refrigerated container.

18. A transport container for transporting cargo, comprising:
a base and a number of wall parts, wherein
at least one transport pallet as claimed in claim 17 is provided as the base and can be connected or is connected to the number of wall parts and/or door-like elements.

19. A transport vehicle, comprising:
at least one electrical or electronic component, such as at least one electric drive, and having at least one transport surface for the arrangement of at least one transport pallet as claimed in claim 17,
wherein the transport vehicle can be provided or is provided with at least one terminal device or connecting device for transferring energy from the at least one rechargeable energy store of the transport pallet to at least one electrical or electronic component of the transport vehicle.

20. A transport vehicle as claimed in claim 19, wherein the transport pallet is in the form of a box or transport container, in particular a refrigerated container, and wherein the at least one rechargeable energy store of the transport pallet is provided for supplying energy for a cooling device for cooling the interior of the transport vehicle or an air conditioning device of the transport vehicle.
